(19) United States
(12) Patent Application Publication
(10) Pub. No.: US 2012/0314433 A1
(43) Pub. Date: Dec. 13, 2012

(54) Apparatus for attaching an incandescent light bulb clip of a lampshade to a spiral shaped compact fluorescent light

(76) Inventors: Brian K. Winchester, Pittsford, NY (US); Christine M. Winchester, Pittsford, NY (US)

(21) Appl. No.: 13/134,602

(22) Filed: Jun. 10, 2011

(51) Int. Cl. F21V 21/08

(52) U.S. Cl. 362/396

(57) ABSTRACT

An apparatus having a base, and legs coupled to the base extending there from for releasably engaging the spiral portion of a CFL along the outer circumference thereof, such that the legs are spaced from each other about the outer circumference of the CFL. Two of the legs opposite each about the CFL circumference each have at least one region enabling engagement to one of the two wire loops of a typical incandescent bulb clip from which a lampshade is supportable.

### FIELD OF THE INVENTION

The present invention relates to an apparatus (or adaptor) for attaching an incandescent light bulb clip of a lampshade to a spiral shaped compact fluorescent light device or lamp (CFL), and particular to, an apparatus which can engage both a CFL and the two metal loops of a typical incandescent light bulb clip. The present invention is useful for adapting a typical bulb clip type lampshade to enable lamps to utilize a CFL.

### BACKGROUND OF THE INVENTION

A popular means for affixing a lampshade to a lamp involves a light bulb clip for attachment directly to the light bulb of the lamp. A light bulb clip typically consists of two metal wire loops which are permanently or releasably attached to the center underside of a lampshade, and are biased towards each other. The two metal wire loops of the bulb clip are fitted over the light bulb, securing the lampshade to the body of the lamp.

So as to improve the energy efficiency of lamps, and thereby reduce cost and minimize impact on the environment, it is often desirable to replace conventional incandescent light bulbs in lamps with a compact fluorescent light (CFL) that are approximately the same size as conventional incandescent light bulbs and can be directly substituted for conventional incandescent bulbs, but which last significantly longer than conventional incandescent bulbs while consuming less energy. However, while the general size of a replacement CFL is usually similar to a conventional incandescent bulb, the shape of a replacement CFL is different from the shape of a conventional incandescent bulb.

A conventional incandescent light bulb typically is rounded and pear-shaped, while the most common CFLs typically consist of gas-filled tubes that have been coiled into a spiral shape. For this reason, a light bulb clip that is configured for firm attachment to a conventional light bulb, will often not attach to a spiral shaped CFL with sufficient friction to maintain the lampshade in position. As a consequence, the lampshade can tip and/or fall off, possibly even damaging the lampshade and/or the lamp.

One possible way to ensure adequate frictional gripping strength of a lampshade light bulb clip is to restrict its use to a replacement fluorescent bulb with a surrounding, transparent, pear-shaped shell. While such light bulbs are currently available to customers, they are significantly more expensive than the far more common spiral shaped CFLs.

Attempts to solve this problem have been made. For example, a silicone composition is placed onto the wire loops of a bulb clip to promote friction when the bulb clip is attached to a spiral shaped CFL (see U.S. Patent Publication No. 2010/0321918). Also, various new types of lampshade clips designed particularly for a spiral shaped CFLs have been proposed without use of a conventional incandescent light bulb clip (see U.S. Patent Application Publication No. 2009/0257235).

### SUMMARY OF THE INVENTION

It is a principal object of the present invention to provide an apparatus for attaching a bulb clip of a lampshade to a spiral shaped compact fluorescent light (CFL) in a lamp.

Briefly described, the present invention embodies an apparatus having a base, and legs coupled to the base and extending there from for releasably engaging the spiral portion of a CFL along the outer circumference thereof, such that the legs are spaced from each other about the outer circumference of the CFL. Two of the legs opposite each about the CFL circumference each have at least one region enabling engagement to one of the two wire loops of a typical incandescent bulb clip from which a lampshade is supportable.

The two wire loops of a typical incandescent bulb clip each engage one of two of the legs of the apparatus already engaged to the CFL along opposite sides thereof. Each of the legs has one or multiple regions for enabling such engagement. When each of the legs has multiple such regions along their length, each of the regions is associated with a nub providing a detent, latch, or catch, for enabling such engagement.

To improve stability between a bulb clip with respect to the apparatus when the legs engage the CFL and the bulb clip, a stabilizer member may be provided which extends upwards from the apparatus's base and abuts against different sides of the two wire loops of the bulb clip.

The apparatus of the present invention thus enables lampshades limited for use with incandescent typical bulb clips to be adapted to engage a spiral shaped CFL, which is desirable since a CFL lasts longer and is more energy efficient over time than typical incandescent light bulbs for approximately the same light output; thus, saving energy and as a result improves the environment. For example, using the apparatus of the present invention to enable just one 18-watt CFL to replace one 75-watt incandescent bulb in a lamp would save over the CFL's typical lifetime about 570 kilowatt-hours of electricity. This replacement would result in a reduction of combustion from power plants using fossil fuels having a positive environmental effect by preventing greenhouse gas emissions from such power plants.

### BRIEF DESCRIPTION OF THE DRAWINGS

The foregoing objects, features and advantages of the invention will become more apparent from a reading of the following description in connection with the accompanying drawings in which:

FIGS. 1A and 1B are two perspective views of the apparatus of the present invention shown attached to a typical CFL in a lamp and a lampshade via a first type of common incandescent bulb clip, in which the lampshade is broken away, and each of FIGS. 1A and 1B show the apparatus at a different angle;

FIG. 1C is another perspective view similar to FIG. 1B, using a second type of common incandescent bulb clip;

FIG. 2 is an exploded view from the apparatus, bulb clip, and CFL of FIGS. 1A and 1B;

FIG. 3 is a top view of the apparatus of FIGS. 1A, 1B, 1C, and 2;

FIG. 4 is a bottom view of the apparatus of FIGS. 1A, 1B, 1C, and 2;

FIG. 5 is perspective view of the apparatus of FIGS. 1A, 1B, 1C and 2 having optional nubs along the legs of the apparatus to assist in engaging the two wire loop members of a bulb clip of FIG. 1A, and 1B, or the bulb clip of FIG. 1C;

FIG. 5A is the same as FIG. 1A showing the nubs of FIG. 5;

FIGS. 6, 7, and 8 are right side, left side, and top views, respectively, of the apparatus of FIGS. 1A, 1B, 1C, and 2 with an optional stabilizer member; and

FIG. 9 is a partial broken side view of FIG. 1A showing the apparatus of the present invention having the stabilizer member of FIGS. 6, 7, and 8 and engaged to both a bulb clip and a CFL.

### DETAILED DESCRIPTION OF THE INVENTION

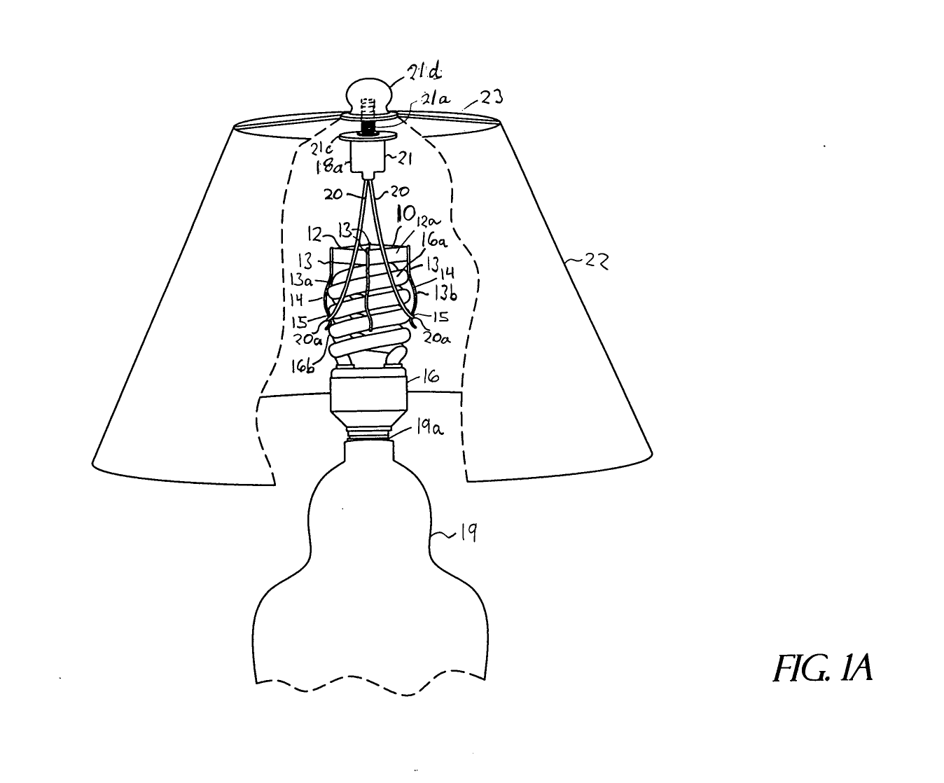

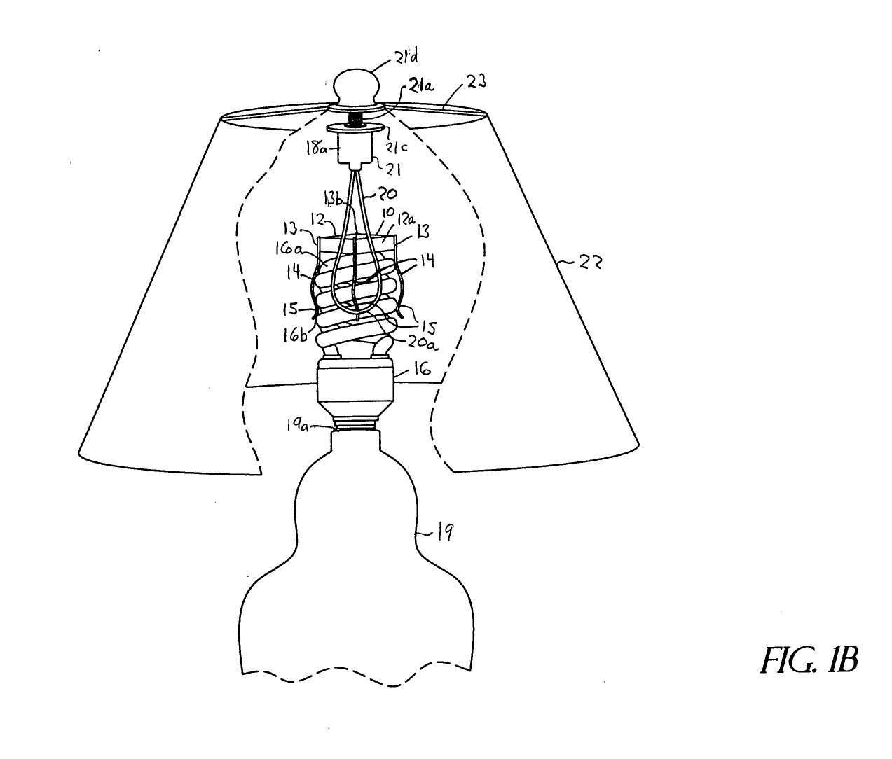

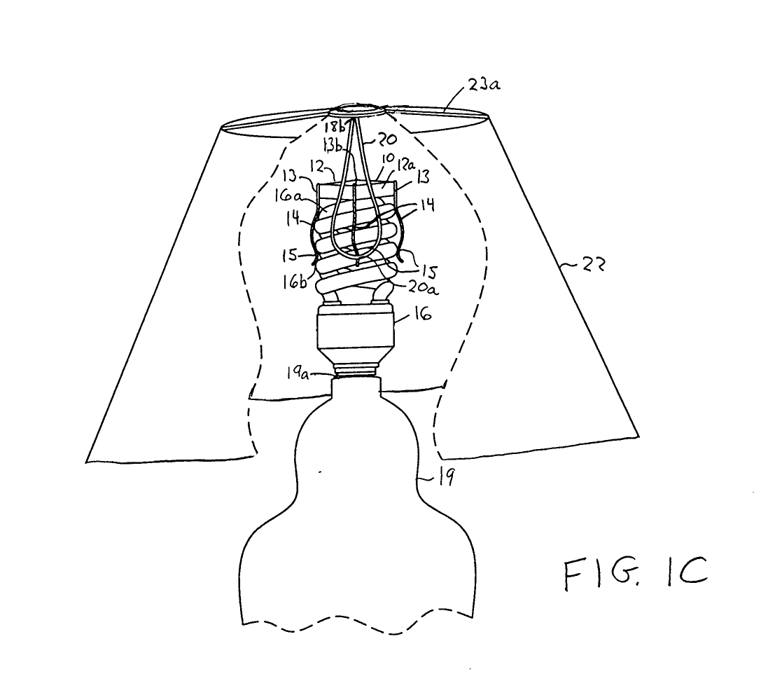

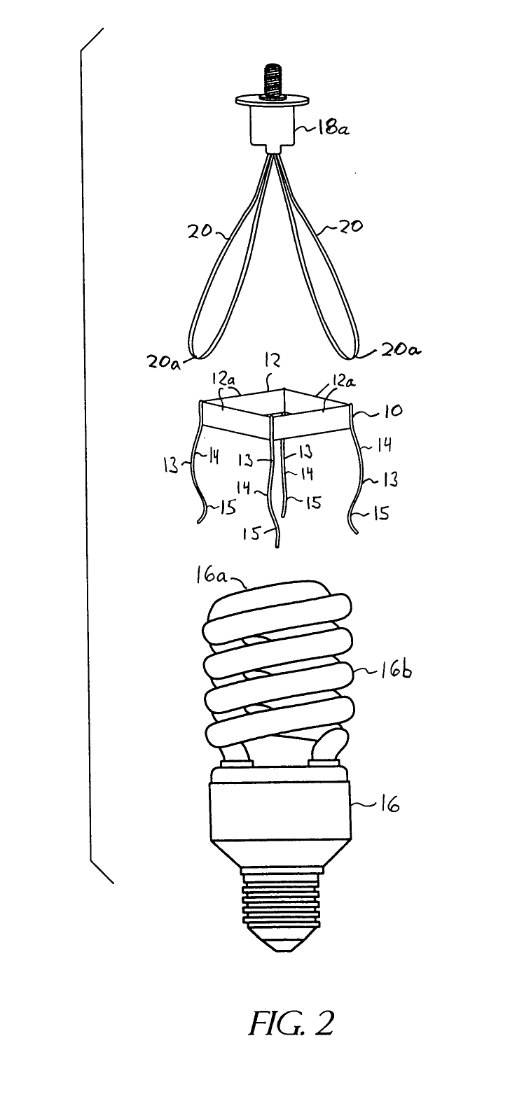

Referring to FIGS. 1A and 1B, the apparatus 10 of the present invention is shown attached to a spiral shaped CFL 16 received in a lamp socket 19a and to two wire loops 20 of a first type of common incandescent bulb clip 18a from which a lampshade 22 is supportable via a lampshade frame 23. FIG. 1C also shows apparatus 10 also attached to spiral shaped CFL 16 and to two wire loops 20 of a second type of common bulb clip 18b for a lampshade frame 23a. Apparatus 10 is shown in FIGS. 2-4 as a separate unit.

Apparatus 10 has a base member (or base) 12 and leg members (or legs) 13 extend from base 12 in a generally downward direction. The base 12 is a square shaped frame and may be assembled from four walls 12a welded together in such shape, as shown in the figures. Thus, between the walls of the base 12 is a space for light from the CFL 16 to extend when powered by the lamp 19 via its socket 19a (FIGS. 1A-1C). For example, base 12 may be of steel or other metal, and each wall 12a may be 1.25 inches long, 0.25 inches width, and 0.025 inches thick. For example, the legs may each be of steel or other metal and rigidly attached along their upper end, such as welded, to the inside or outside corners of the base 12. Such wire may be, for example, 0.075 inches in diameter, and extend about 1.875 inches below base 12. Other dimensions may also be used for base 12 and legs 13.

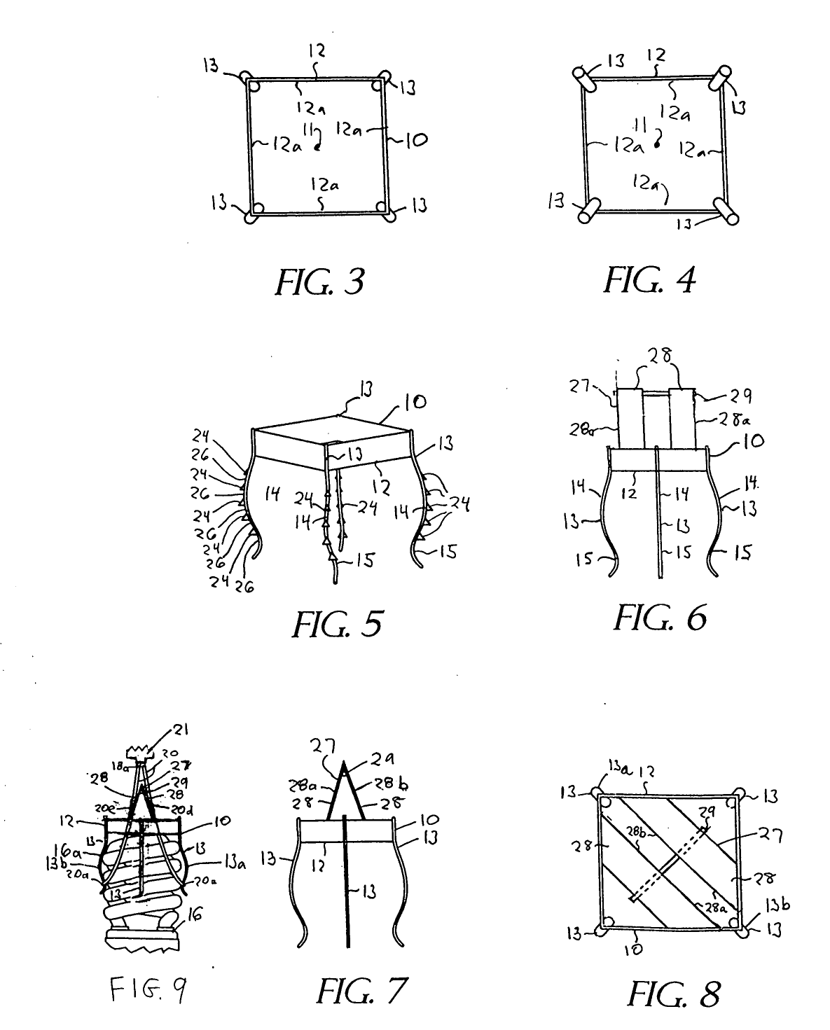

Extending from base 12 each leg 13 is bent to provide curvature having a first outward curved region 14 and second inward curved region 15. Each pair of opposite legs 13 extend from opposite corners of base 12 have opposing curved regions 14 bulging outward in opposite directions radially along a virtual cylindrical axis 11 extending equidistant between legs 13, where axis 11 extend into and out of the page illustrating FIGS. 3 and 4. Similarly, each pair of opposite legs 13 extend from opposite corners of base 12 have opposing curved regions 15 bulging inward in opposite directions radially along the virtual cylindrical axis 11.

The curvature of leg 13 enables apparatus 10 to releasably engage the spiral portion 16a of a CFL 16 along the outer surface about the CFL's circumference 16b. Legs 13 extend partially along spiral portion 16a from the top thereof, such as shown in FIGS. 1A, 1B, and 1C. Legs 13 are spaced (preferably equally) about the CFL circumference 16b characterized by the outermost surfaces of the CFL's spiral glass about its cross-sectional diameter, and engage outermost surfaces of the CFL's spiral glass. In other words, CFL 16 and apparatus 10 have the same or approximately the same virtual cylindrical axis 11 when apparatus 10 is properly engaged with CFL 16 such as illustrated in FIG. 1A, 1B, or 1C for example. When so engaged, base 12 lies horizontally level (or approximately horizontally level) above and across the top of CFL 16. The legs may be other cross-sectionally shapes than circular, such as rectangular with flat side, oval, or other shape.

Legs 13 in response to receiving a CFL 16 in the space between such legs below base 12 bend slightly outward as they contact the outermost glass of CFL 16 to assist in frictional engagement to the CFL 16 needed to later support the weight of clip 18a or 18b and the lampshade 22 supported there from. As such, legs 13 are preferably biased by their rigid attachment to base 12 in a direction toward axis 11. In this manner a user (with the lampshade 22 and clip 18a or 18b not present) can align apparatus 10 with legs 13 downward and base extending above the CFL and then by positioning apparatus 10 downward legs 13 clip (frictionally engage) onto spiral portion 16a to easily clip apparatus 10 onto the CFL from the top thereof, such that base extends across above the top of CFL 16. The base may or may not contact the CFL 16.

If needed, prior to placement of apparatus 10 (or if its clip on bias cannot sufficiently frictionally engage the CFL 16 as needed to support later the weight of the clip 18a or 18b and a lampshade permanently (FIG. 1C) or releasably (FIG. 1B) coupled thereto), a user may squeeze each of the two pairs of opposing legs 13 to bend them slightly more towards each other (without deforming their curvature) to increase their clip on bias or force upon the CFL 16. Also, when desired, the user without clip 18a or 18b present can pull up apparatus 10 by its base 12 to release legs 13 from the CFL and thereby remove apparatus 10 from CFL 16.

The two types of bulb clips 18a and 18b of FIGS. 1A and 1B, or FIG. 1C, respectively, each have the same type of loops 20, but are coupled to lampshade 22 differently. In FIGS. 1A and 1B, bulb clip 18a has a member 21 from which the two wire loops 20 downwardly extend, such as shown in the figure, biased towards each other. The upper portion of member 21 has a threaded bolt 21a receivable through a central circular opening in frame 23 such that about this circular opening an annular upper flange 21c of member 21 supports the lampshade 22. A nut 21d is tightened over threaded bolt 21a to stabilize the lampshade's frame 23 upon member 21 and couple bulb clip 18a to frame 23. Thus bulb clip 18a and shade 22 releasably attach. In FIG. 1C, bulb clip 18b is part of frame 23a or directly coupled thereto, such as welded or otherwise permanently attached without member 21 so that two wire loops 20 centrally extend downward from the frame, such as shown in this figure, and are biased towards each other. The present invention is not limited for use with any particular type of frame or bulb clip or integration (or coupling) thereof, so long as the bulb clip has two wire loops 20 biased towards each for enabling typical engagement to an incandescent light bulb.

With apparatus 10 engaged to a spiral shaped CFL, the two wire loops 20 of bulb clip 18a or 18b are located over apparatus 10. In the case of clip 18a, clip 18a may be located over apparatus 10 before or after clip 18a is coupled to lampshade frame 23, as described above. The two wire loops 20 are pulled slightly apart from each other (as they are typical biased toward each other) by the user while placing ends 20a of the loops 20 over a pair of two opposite legs 13 about the CFL, such as legs 13a and 13b, as shown in FIG. 1A, such that ends 20a are received and engage regions 15 of the pair of opposing legs 13a and 13b. As apparatus 10 is at least approximately horizontal level, then clip 18a or 18b and lampshade 22 coupled thereto will be approximately level. If not so level, apparatus 10 can be repositioned slightly upon the CFL with the clip 18a or 18b and lampshade 22 (if coupled thereto in the case of clip 18a), as desired by the user. The bias of wire loops 20 may further assist in the engagement of apparatus 10 by its legs 13a and 13b to the CFL. In this manner, bulb clip 18a and 18b are engaged with the apparatus 10. Although loop portions clip on to legs 13a and 13b, the other pair of legs 13 may instead similarly engage wire loops 20. Also, instead of, or in addition to the curvature of region 15 along legs 13, one or more legs may have a notch, groove, channel, deformation, indentation, or other such means for releasable engaging a loop end 20a.

Four legs 13 are shown mechanically coupled to base 12, such as by welding or other attachment means. However, more than four legs may be used, and base 12 may be of other geometrical shape than square, such as hexagonal or circular, depending on the number of legs present. Regardless of the number of legs of apparatus 10, it is preferred that at least two of such legs are opposite each other to enable engagement by the bulb clip 18a or 18b as described above. For example, base 12 may have six or eight legs, and base is adapted to have a shape for supporting such legs. Four legs 13 are preferred as this provides sufficient stability without significantly blocking light from the CFL. Any material can be used to provide base 12 and legs 13 which can withstand the range of temperature of typical CFL wattages and sufficiently rigid to engage onto the CFL and support the weight of bulb clip 18a or 18b and shade 22 supported there from.

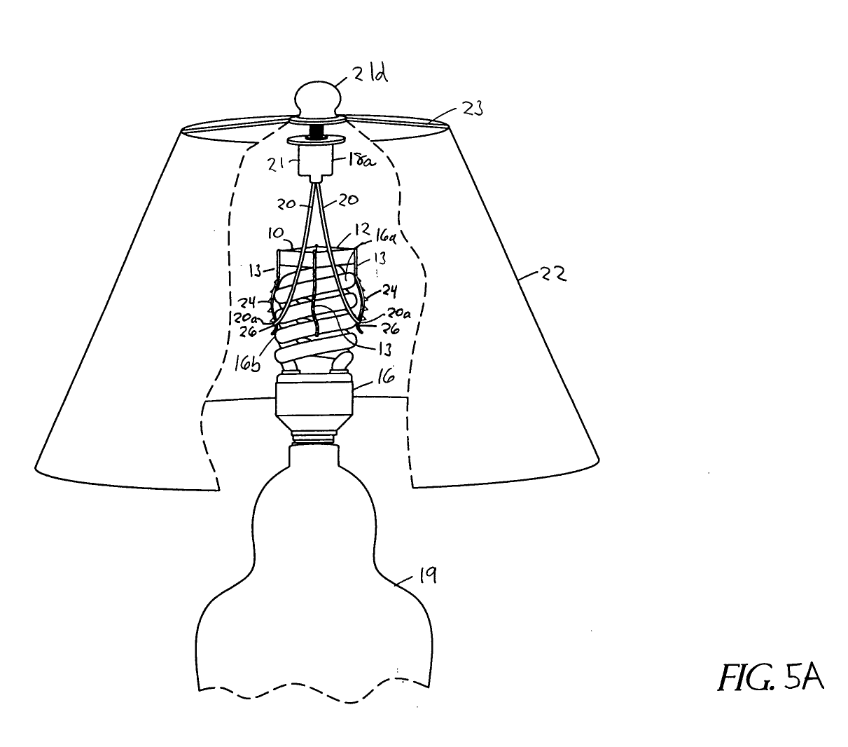

Although only one region 15 for enabling engagement to bulb clip 18a and 18b, one or multiple regions may be provided along legs 13, such as shown in FIG. 5. In this case, each leg 13 has spaced nubs 24 which outwardly project along its length below base 12. Between each nub 24 is a region 26 into which the bottom 20a of a wire loop 20 may be received, and thus nubs 24 and regions 26 alternate along legs 13, as shown for example for clip 18a of FIG. 5A. The nubs 24 provide detents or catches for bottom 20a of wire loops 20. The nubs may be of scale shaped metal, such as of steel, attached along the legs 13. Although all of the legs 13 are shown with nubs 24 in FIG. 5, only the pair of opposing legs 13 need the nubs, such as shown in the FIG. 5A example.

Engagement of clip 18a or 18b onto apparatus 10 with nubs 24 is the same as described above, but with a plurality of regions 26 into which ends 20a of wire loops 20 of clip 18a or 18b are received. Preferably, ends 20a of wire loops 20 along the pair of opposing legs 13 are received in regions 26 which are the same distance from base 12, so as to avoid clip 18a or 18b not being horizontal (or approximately horizontal) level when engaging apparatus 10. Preferably, the bottommost region 26 in common with region 15, is used to engage bulb clip 18a or 18b. Although multiple nubs are shown, a single nub 24 may instead be provided along the legs 13 above region 15 of FIGS. 1A, 1B, 1C and 2 to provide a releasable latching mechanism for bulb clip 18a or 18b. Instead of, or in addition to nubs 24, each of the regions 26 may have a notch, groove, channel, deformation, indentation, or other such means for releasably engaging a loop end 20a.

To stabilize apparatus 10 to clip 18a or 18b and better support the weight of clip 18a or 18b and lampshade 22 attached thereto, apparatus 10 may have a stabilizer member 27 as shown in FIGS. 6-8. Stabilizer member 27 has a pair of wedges 28 extending upwards from base 12. The wedges 28 are coupled at the top thereof by a pin or shaft 29. Each of the pair of wedges 28 is formed by a flange 28a and a flange 28b which are welded or otherwise joined with pin 29 at the top thereof, and the bottom of flange 28a and flange 28 are welded or otherwise attached to the top of base 12. The wedges 28 may extend about 0.9 inches from base 12, and may be made from the same material as base 12.

Stabilizer member 27 is sized and triangular in shape to be positionable in the space between two loop portions 20 of bulb clip 18a or 18b when apparatus 10 with attached stabilizer member 27 engages both a bulb clip and a CFL and opposing legs 13a and 13b engage loop portions 20, as described earlier. When so positioned, at least a portion of the stabilizer member 27 abuts against loop portions 20, such as shown for example in the partial broken view of FIG. 9, to enable the desired stabilization. For example, at least a portion of flanges 28a abut against the two sides forming wire loop 20d, and at least a portion of flanges 28b abut against the two sides forming wire loop 20e. Preferably, wedges 28 are joined at the top thereof by pin 29 and are spaced from each other sufficient to enable such engagement against at least a part of loop portions 20 that extend above base 12. Although FIG. 9 shows bulb clip 18a, apparatus 10 with attached stabilizer member 27 may also be used with bulb clip 18b of FIG. 1C.

Each of the legs 13 of apparatus 10 in the figures may have a coating or layer of material to assist or enhance frictional engagement onto a CFL 16, sufficient to withstand the temperature range of a CFL. For example, such material may be silicone.

From the foregoing description, it will be apparent that an apparatus for attaching a bulb clip of a lampshade to a spiral CFL has been provided. Variations and modifications of the herein described apparatus and other applications for the invention will undoubtedly suggest themselves to those skilled in the art. Accordingly, the foregoing description should be taken as illustrative and not in a limiting sense.

1. An apparatus for attaching a lamp shape with a bulb clip onto a spiral shaped compact fluorescent light (CFL), said bulb clip having two loop portions biased towards each other, said apparatus comprising:
a plurality of mechanically coupled members for engaging a CFL along the outer circumference thereof; and
at least two of said members are disposed about the outer circumference and have one or more regions for enabling engagement to one of the two loop portions of a bulb clip.

2. The apparatus according to claim 1 wherein said members at least partially extend along the outer circumference of the CFL, spaced from each other about the circumference of the CFL, and are bendable outward to enable said members to engage the CFL.

3. The apparatus according to claim 1 wherein said members are equally spaced from each other about the circumference of the CFL when said members engage the CFL.

4. The apparatus according to claim 1 wherein said one or more regions of each of said at least two of said members enable engagement to one of the two loop portions of a bulb clip at the lowest end of the loop.

5. The apparatus according to claim 1 wherein said members number four or more.

6. The apparatus according to claim 1 wherein said at least two of said members each has a single one of said one or more regions along the member for enabling engagement to the bottom of one of the two loop portions of a bulb clip.

7. The apparatus according to claim 6 wherein said members are legs and said legs providing said at least two of said member have a bend providing said single one of said one or more regions.

8. The apparatus according to claim 1 wherein said member each have a plurality of said regions along the member for capturing the bottom of one of the two loop portions of a bulb clip.

9. The apparatus according to claim 8 wherein said member each have a plurality of detents along the member each of said detents being associated with a different one of said plurality of regions along the member.

10. The apparatus according to claim 9 wherein each of said plurality of detents are provided by a nub.

11. The apparatus according to claim 1 further comprising a base and said members are mechanically coupled to said base and extend there from.

12. The apparatus according to claim 11 wherein said members extend downward from said base to enable engagement of a CFL along the circumference thereof.

13. The apparatus according to claim 11 wherein said members are legs extending from said base and having curvature facilitating engagement about the circumference of the upper portion of a CFL.

14. The apparatus according to claim 13 wherein the legs providing said at least two of said members each have a plurality of said regions, and a plurality of projecting nubs alternating with said plurality of said regions, in which each of said nubs provide a detent for one of the plurality of regions below the detent for capturing the bottom of one of the two loop portions of a bulb clip.

15. The apparatus according to claim 11 wherein said base comprises a stabilizer positionable between said loop portions for stabilizing said bulb clip with respect to said apparatus when said members engage the CFL.

16. The apparatus according to claim 15 wherein said stabilizer comprises a pair of wedges extending upwards from said base each abutting against different sides of the two loop portions.

17. The apparatus according to claim 1 wherein said members have a layer of material enhancing engagement with a CFL.

18. The apparatus according to claim 1 wherein one or more of said members further comprise means for releasably engaging one of the two loop portions of a bulb clip.

19. An adapter for attaching an incandescent light bulb clip of a lampshade to a spiral shaped compact fluorescent light (CFL), said bulb clip having two wire loop portions biased towards each other, said adapter comprising:
a base;
a plurality of legs coupled to said base and extending there from for releasably engaging the spiral portion of a CFL along the outer circumference thereof, in which said legs are spaced from each other about the outer circumference of the CFL; and
at least two of the legs opposite each other about the CFL circumference each have at least one region enabling engagement to one of the two loops of an incandescent bulb clip from which a lampshade is supportable.

20. The adapter according to claim 19 wherein said at least two of said legs each have a detent, bend, or nub along the leg associated with said region along the leg.

21. The adapter according to claim 19 further comprising one or more wedges extending upwards from said base each abutting against different sides of the two loop portions.
